(19) United States
(12) Patent Application Publication
(10) Pub. No.: US 2006/0132681 A1
(43) Pub. Date: Jun. 22, 2006

(54) Reflective liquid crystal display

(76) Inventors: Young Il Park, Seoul (KR); Dong Hae Suh, Daegu (KR); Hee Cheol Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 10/626,152

(22) Filed: Jul. 24, 2003

(30) Foreign Application Priority Data
Jul. 29, 2002 (KR) 2002-44723
Apr. 11, 2002 (KR) 2002-67837

(51) Int. Cl. G02F 1/1335

(52) U.S. Cl. 349/113

(57) ABSTRACT

A reflective liquid crystal display of the present invention is disclosed. The reflective liquid crystal display of the present invention comprising: a lower substrate including a reflective electrode and a lower orientation film; an upper substrate opposed to the lower substrate, the upper substrate including a transparent substrate and an upper orientation film, the transparent substrate being capable of compensating a phase of λ/4 with an optical axis of a predetermined angle, the upper orientation film being formed on a surface of the transparent substrate opposed to the lower substrate; a twisted nematic liquid crystal layer interposed between the lower substrate and the upper substrate, including a predetermined phase delay value (dΔ n); and a polarizing plate attached to a outer surface of the upper substrate not opposed to the lower substrate, having a predetermined polarizing axis. The present invention enables the phase compensation of the upper substrate to remove the using of the expensive phase film, so that it is possible to reduce production cost and simplify a manufacturing procedure.

### BACKGROUND OF THE INVENTION

1. Field of the Invention

The present invention relates to a reflective liquid crystal display, and more particularly to a reflection type liquid crystal display not using a phase compensating film.

2. Description of the Prior Art

As is generally known in the art, since a reflective liquid crystal display without a back-light has a low power consumption and a compact size, and is very light in weight, it has been useful for portable display devices, and as the market for portable cell phones and portable apparatuses is growing wider, the demand for the reflective liquid crystal display is gradually increasing.

Such reflective liquid crystal displays have a structure comprising a lower substrate, a reflective electrode, a lower orientation film, a liquid crystal layer, an upper orientation film, an upper transparent electrode, a color filter, an upper substrate, a phase film, and a polarizing plate, laminated in this order.

Here, phases of a liquid crystal used in the reflective liquid crystal display can be categorized a nematic phase, a cholesteric phase, and so on. In the case of using the nematic phase, the molecules of the liquid crystals may be arranged in patterns such as homogeneous, homeotropic, hybrid, twisted and the like.

Among these liquid crystal arrangements, the Twisted Nematic (hereinafter, referred to as a “TN”) is a form of sequentially twisted liquid crystals between two substrates.

FIG. 1 is a cross sectional view schematically showing a conventional reflective liquid crystal display having a TN mode. As shown in the FIG. 1, a lower substrate 1 on which disposed a reflective electrode 2 and a lower orientation film 3, and the upper substrate 4 on which disposed a color filter 5 and a upper orientation film 6 are arranged so as to face with each other with a liquid crystal layer 10 interposed therebetween. On the outer surface of the upper substrate 4 not opposed to the lower substrate 1, a phase compensating film, namely λ/4 film 7 and a polarizing plate 8 are sequentially provided.

The λ/4 film 7 is a uniaxial orientation film to compensate a phase of the TN liquid crystal, and its optical axis has an angle of 45° with respect to a polarization axis of the polarizing plate. The liquid crystal layer 10 has a twist angle of 90°.

The display of the reflective liquid crystal display employing the TN liquid crystal mode is implemented by optical characteristics as follows.

First, when no voltage is applied to the liquid crystal, a light which is linearly polarized while passing through the polarizing plate is converted into a circularly polarized light, for example, a left-circular polarized light, while passing through the λ/4 film, and then the light is converted into a linearly polarized light while passing through the liquid crystal layer and is reflected from the reflective electrode. Further, the linearly polarized light which is reflected from the reflective electrode is converted to a left-circular polarized light while passing through the liquid crystal layer, and then it is converted into a linearly polarized light whose polarization direction is parallel to the polarization axis of the polarizing plate while passing through the λ/4 film, and it passes through the polarizing plate, so that it is possible to achieve a state of a white display.

Next, when a voltage is applied to the liquid crystal, a light is converted to a left-circular polarized light while passing through the polarizing plate and the λ/4 film, and it passes the liquid crystal layer without any conversions, and it is converted to a right-circular polarized light with reflection at the reflective electrode. Further, the right-circular polarized light is converted to the linearly polarized light whose polarization direction is perpendicular to the polarization axis of the polarizing plate, and it does not pass through the polarizing plate, so that it is possible to achieve a state of a dark display.

Meanwhile, a display quality of the reflective liquid crystal display is overwhelmingly dependent upon how the characteristic values of above-mentioned components of the display are optimized. Specifically, in order to effectively increase a reflectance of the reflective liquid crystal display, it is necessary to optimize an angle of the polarization axis of the polarizing plate, optical characteristics of the phase compensating film, thickness of the liquid crystal layer, the double refractivity of the liquid crystal layer, the twist angle of the liquid crystal, characteristics of the reflective plate, etc.

However, although the aforementioned conventional reflective liquid crystal display comprises a phase compensating film, i.e., λ/4 film, which can realize a good display owing to the λ/4 phase difference in the wide area of visible light wavelength, the conventional reflective liquid crystal display has problems in that the production cost is significantly increased and the manufacturing process is complex, since the phase compensating film is ten times more expensive than a commonly used polarizing plate.

### SUMMARY OF THE INVENTION

Accordingly, the present invention has been made to solve the above-mentioned problems occurring in the prior art, and an object of the present invention is to provide a reflective liquid crystal display for significantly reducing production costs and simplifying complex manufacturing processes due to a use of any phase compensating films.

In order to accomplish this object, there is provided a reflective liquid crystal display, comprising: a lower substrate including a reflective electrode and a lower orientation film; an upper substrate opposed to the lower substrate, the upper substrate including a transparent substrate and an upper orientation film, the transparent substrate being capable of compensating for a phase of λ/4 with an optical axis of a predetermined angle, the upper orientation film being formed on a surface of the transparent substrate opposed to the lower substrate; a twisted nematic liquid crystal layer interposed between the lower substrate and the upper substrate, with a predetermined phase delay value (dΔ n); and a polarizing plate attached to a outer surface of the upper substrate not opposed to the lower substrate, having a predetermined polarizing axis.

Here, the transparent substrate capable of compensating the phase of λ/4 is a glass substrate for completely circular-polarizing a light of 550 nm wavelength. Also, the transparent substrate capable of compensating the phase of λ/4 is a glass substrate for changing a phase of a light of 550 nm wavelength into λ/2.

The lower orientation film has a orientation angle of 0˜10° with respect to a horizontal line. The upper orientation film has a orientation angle of −50˜−54° with respect to a horizontal line. The liquid crystal layer has a phase delay value of 0.15˜0.17 μm, and the liquid crystal layer has a twisted angle of 50˜60° with respect to the left direction. The polarizing plate has a polarizing axis with an angle of 112˜120° with respect to a horizontal line.

The reflective electrode has a flexural surface. Moreover, the present invention provide a reflective liquid crystal display comprising: a lower substrate including a reflective electrode; a lower orientation film formed on the reflective electrode, having an angle of 0˜10° with respect to a horizontal line; an upper substrate opposed to the lower substrate, being made of transparent substrate capable of compensating a phase of λ/4 with an optical axis of a predetermined angle; an upper orientation film formed on the upper substrate, having orientation angle of −50˜−54° with respect to a horizontal line; a twisted nematic liquid crystal layer interposed between the lower substrate and the upper substrate, with a predetermined phase delay value (dΔ n) of 0.15˜0.17 μm, having twist angle of 50˜60° with respect to the left direction; and a polarizing plate attached to a outer surface of the upper substrate not opposed to the lower substrate, having a predetermined polarizing axis with an angle of 112˜120° with respect to a horizontal line.

### BRIEF DESCRIPTION OF THE DRAWINGS

The above and other objects, features and advantages of the present invention will be more apparent from the following detailed description taken in conjunction with the accompanying drawings, in which:

FIG. 1 is a cross sectional view showing a conventional reflective liquid crystal display.

FIG. 2 is a cross sectional view showing a reflective liquid crystal display according to an embodiment of the present invention.

FIG. 3A is a graph illustrating a design range of a TN liquid crystal in a reflective liquid crystal display according to the present invention.

FIG. 3B is a diagrammatic view showing an axis arrangement of components in a reflective liquid crystal display according to the present invention.

FIGS. 4A and 4B are diagrammatic views for explaining polarization characteristics in a reflective liquid crystal display according to the present invention.

FIGS. 5 and 6 are graphs for explaining reflectance characteristics of voltages in a reflective liquid crystal display according to the present invention.

FIGS. 7A and 7B are graphs illustrating reflectance characteristics of the left-right sides and upper-lower sides viewing angle in a reflective liquid crystal display according to the present invention when applying a voltage to the liquid crystal.

FIGS. 8A and 8B are graphical representations illustrating characteristics of a contrast ratio for the left-right sides and upper-lower sides viewing angle of a polarizing plate in a reflective liquid crystal display according to the present invention.

FIG. 9 is a graph illustrating characteristics of a contrast ratio for an applied voltage in a reflective liquid crystal display according to the present invention.

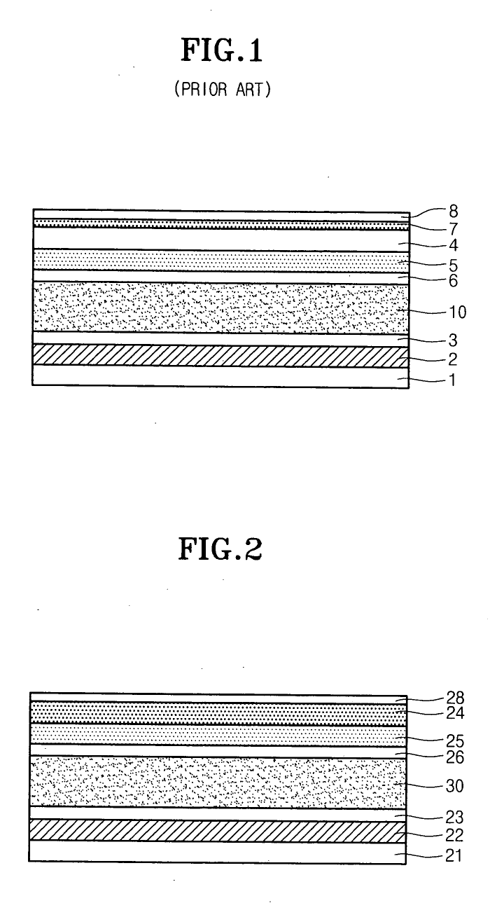

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

FIG. 2 shows a reflective liquid crystal display in accordance with the embodiment of the present invention.

As shown in FIG. 2, the reflective liquid crystal display in the present invention is comprised of a lower substrate 21 having a reflective electrode 22 and a lower orientation film 23, and an upper substrate 24 having a color filter 25 and an upper orientation film 26, which form into TN liquid crystal and are disposed to face each other due to an interposed liquid crystal layers having a predetermined phase delay value (dΔ n), and there is only a polarizing plate attaching onto outside of the upper substrate 23 opposed to the lower substrate 21 without a phase compensation film.

Here, the lower orientation film 23 is tilted at a predetermined angle with respect to a horizontal line, and a orientation angle of the upper orientation film 26 has a constant angle with the upper orientation film 23.

Especially, the upper substrate 23 is constructed for acting as the phase compensation film. In other words, the substrate 23 is a transparent film with λ/4 transparency having a certain optical axis capable of compensating phase. Here, a glass substrate making light of 550 mm wavelength to a circularly polarized light, and a glass substrate changing a wavelength of light phase from 550 mm to λ/2 can be used as the transparent film with λ/4 transparency capable of compensating phase.

The reflective electrode 22 has an uneven surface, and the forming method is as follows.

First, spacer is sprayed on the substrate coated with resin film and irradiated in order that the spacer is inlayed. Then, the spacer is rubbed for eliminating and fine concave and convex in shape of random are formed on the resin film. An electrode material is coated on the resin film having fine concave and convex in form of random, thereby a reflective electrode having an uneven surface is formed.

Since the reflective liquid crystal display of the present invention uses a glass substrate of λ/4 transparency as an upper substrate, an expensive phase compensation film is no longer required. Accordingly, it can cut down on unnecessary expense and simplify manufacturing process due to unnecessary process of attaching a phase compensation film.

In addition, the reflective liquid crystal display of the present invention can control an optical path, which cannot be compensated by using only a cell gap of the inside of cell and by double refraction value (Δ n) of liquid crystal, by means of using an upper substrate having a phase compensating function, also can feely adjust phase delay value (d Δ n) of entire cells within 0.2˜0.53.

Meanwhile, when the λ/4 glass substrate instead of a phase compensation film is applied as an upper substrate, in order to obtain a good quality display, it needs to optimize an angle of polarization axis which is coincided with an optical axis of the λ/4 glass substrate and rubbing angle which determines a twist angle of a liquid crystal, so as to have high reflection ratio and contrast ratio.

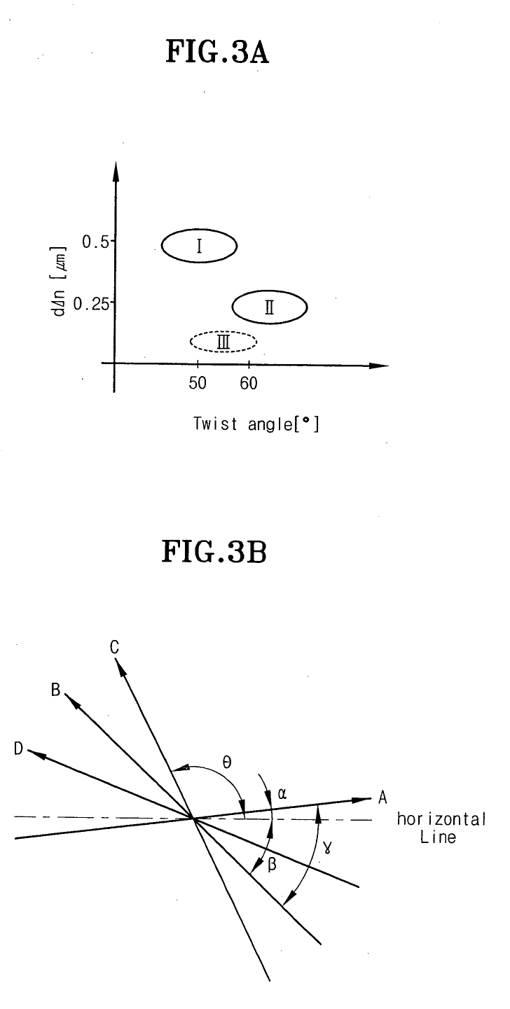

FIG. 3A is a graph showing a range of double refraction of TN liquid crystal in the reflective liquid crystal display of the present invention, and FIG. 3B is a diagrammatic view showing an axis arrangement of each components in a reflective liquid crystal display according to the present invention.

Referring to FIG. 3A, in the case of Group I and II according to the conventional art, a design range of phase delay value of liquid crystal layer is about 0.45˜0.53 μm and 0.20˜0.27 μm, respectively. However, in the case of Group III according to the present invention, it shows the most desirable double refractivity that the design range is 0.15˜0.17 μm, is desirably about 0.1568 μm, the twist angle is 50˜60° with respect to the left direction, desirably is 60°.

Referring to FIG. 3B, a rubbing axis A of angle α with respect to the lower substrate is about 0˜10° with respect to a horizontal line, a rubbing axis B of angle β with respect to the lower substrate is about −50 to −54°, a twist angle γ formed by the rubbing axis A with respect to the lower substrate and the rubbing axis B with respect to the upper substrate is about 54°, and a polarizing axis C of angle θ with respect to the polarizing plate is about 112 to 120°, desirably about 116°. An unexplained reference character D is for an optical axis of λ/4 glass substrate.

In accordance with FIG. 3A and FIG. 3B, if the orientation angle α with respect to the lower orientation film is about 0˜10°, the orientation angle β with respect to the upper orientation substrate is about −50˜−54°, the phase delay value of the liquid crystal layer is about 0.15˜0.17 μm, the twist angle γ with respect to the left direction is about 54°, and the polarizing axis θ of the polarizing plate is about 112˜120°, the reflective liquid crystal display of the present invention can have high reflectance and contrast ratio, and thereby can obtain a good qualified display.

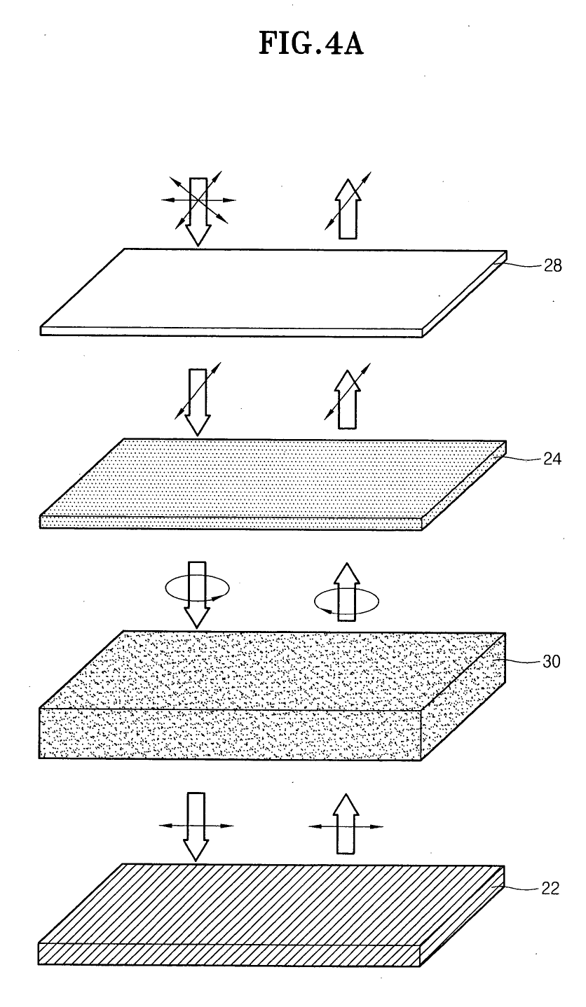

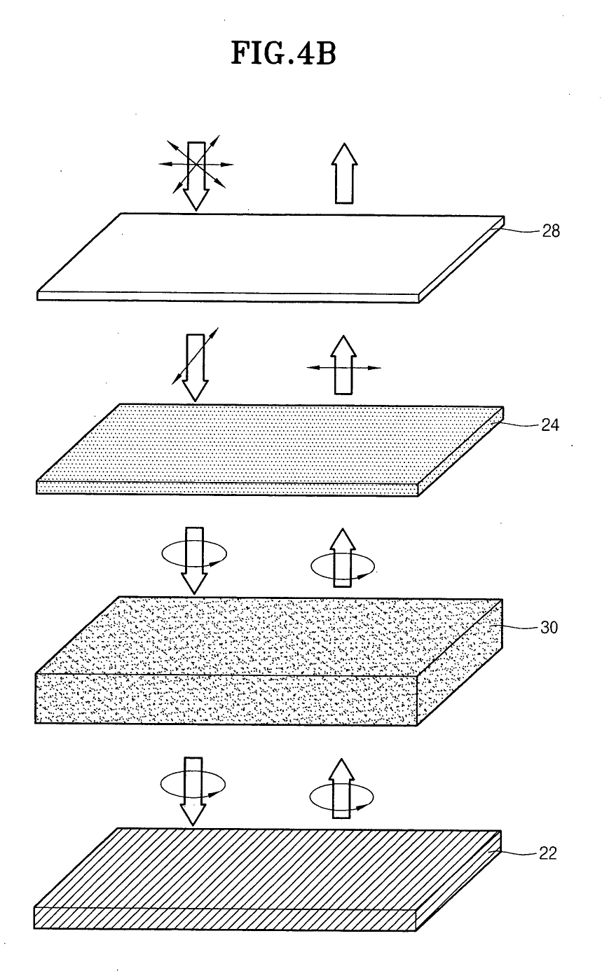

FIG. 4A and FIG. 4B are diagrammatic views for explaining polarization characteristics in a reflective liquid crystal display according to the present invention. Here, identical parts with FIG. 2 are shown as identical reference characters.

Referring to FIG. 4A, when no voltage is applied to the liquid crystal, a light which is linear polarized while passing through the polarizing plate 28 is converted to a circular polarized light, for example a left-circular polarized light, while passing through the upper substrate 24, and then the light is converted to a linear polarized light while passing through the liquid crystal layer 30 and is reflected from the reflective electrode 22. Further, the linear polarized light reflected from the reflective electrode 22 is converted to a left-circular polarized light while passing through the liquid crystal layer 30, and then it is converted to a linear polarized light whose polarization direction is parallel to the polarization axis of the polarizing plate through the upper substrate 24, and it passes through the polarizing plate 28, so that it is possible to achieve a state of a white display.

Referring to FIG. 4B, when a voltage is applied to the liquid crystal, a light is converted to a left-circular polarized light while passing through the polarizing plate 28 and the upper substrate 24, and it passes the liquid crystal layer 30 without any conversion, and it is converted to a right-circular polarized light with reflection at the reflective electrode 22. Further, the right-circular polarized light is converted to the linear polarized light while passing through the liquid crystal layer 30 and the upper substrate 24, a polarization direction of the linear polarized light is perpendicular to the polarization axis of the polarizing plate, and it does not pass through the polarizing plate 28, so that it is possible to achieve a state of a dark display.

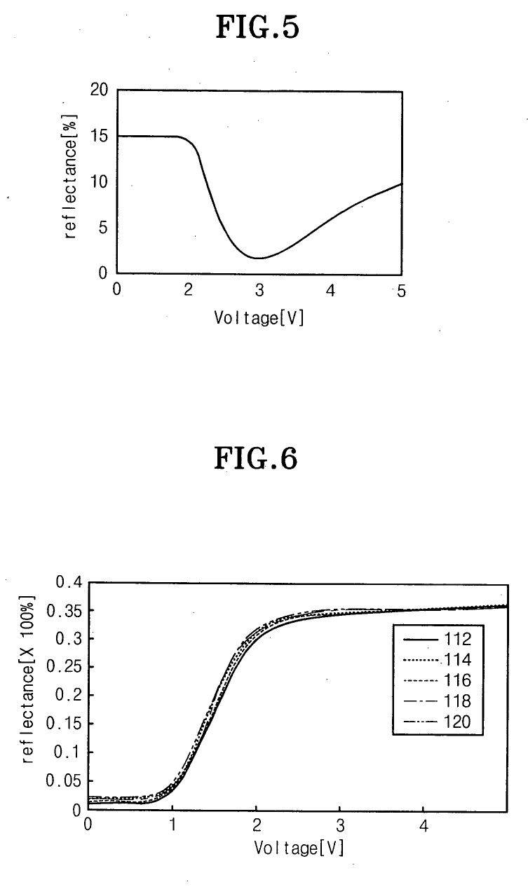

FIG. 5 and FIG. 6 are graphical representations for explaining reflectance of voltage in the reflective liquid crystal display according to the present invention. Here, FIG. 5 is a graphical representation showing reflectance of voltage in a reflective TN mode liquid crystal display of Matsushita Company, and FIG. 6 is a graphical representation showing reflectance of voltage in the reflective liquid crystal display according to the present invention.

Comparing FIG. 5 with FIG. 6, it is shown that the reflective liquid crystal display (FIG. 6) of the present invention has such more reflectance than that of the reflective liquid crystal display (FIG. 5) of Matsushita Company.

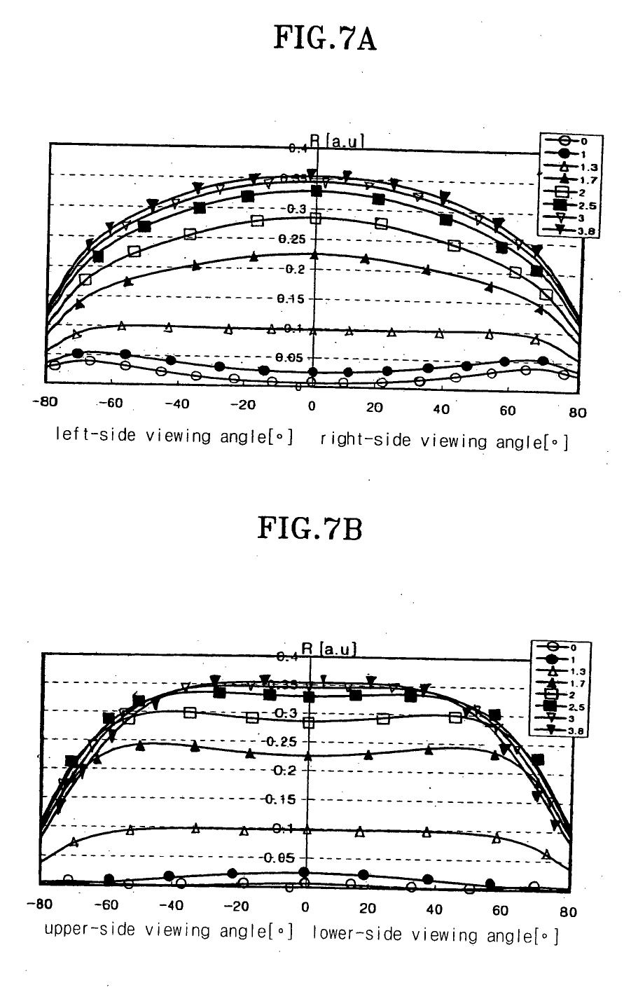

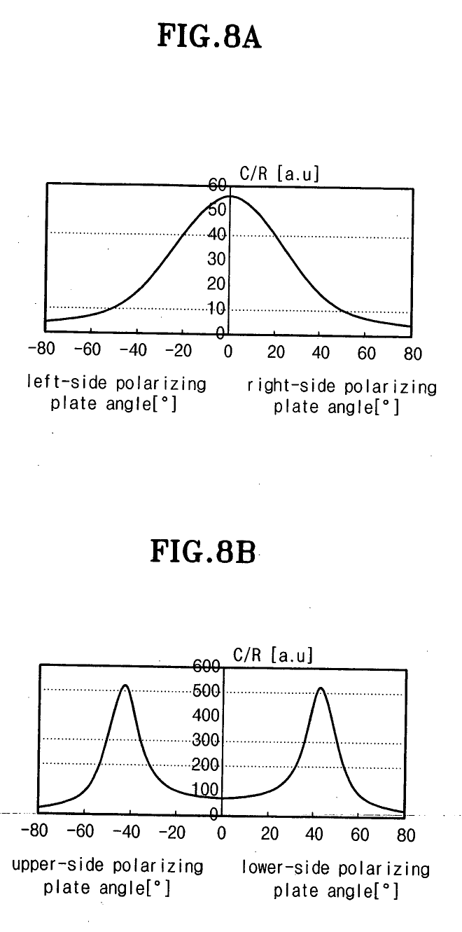

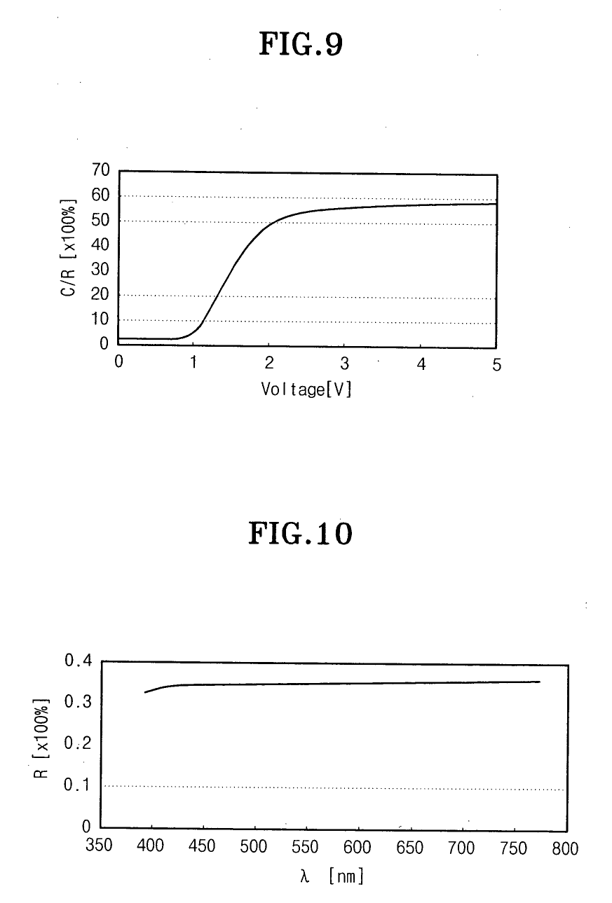

FIG. 7A, FIG. 7B, FIG. 8A, FIG. 8B, FIG. 9 and FIG. 10 are graphical representations illustrating characteristics of the reflective liquid crystal display according to the present invention. Here, FIGS. 7A and 7B are graphs illustrating characteristics of reflectance R for left-right sides viewing angle and upper-lower sides viewing angle respectively in period of voltage application of the reflective liquid crystal display according to the present invention. FIGS. 8A and 8B are graphs illustrating characteristics of contrast ratio (C/R) for left-right sides angle and upper-lower sides angle of the polarizing plate in the reflective liquid crystal display according to the present invention. FIG. 9 is a graph illustrating characteristics of contrast ratio C/R regarding to the applied voltage V of the reflective liquid crystal display according to the present invention. FIG. 10 is a graph illustrating characteristics of reflectance R regarding to wavelength λ of the reflective liquid crystal display according to the present invention.

As shown in figures, it will be appreciated that the reflective liquid crystal display according to the present invention is excellent, with the reflectance characteristic regarding to viewing angle, the contrast ratio C/R regarding to angle, and the contrast ratio C/R regarding to a applied voltage.

Further, it will be appreciated that the reflective liquid crystal display according to the present invention has a reflectance R having a minimized dependency on the wavelength λ.

As is described in the above, by using a glass substrate a wavelength of λ/4 having a predetermined optical axis instead of phase compensating film, Accordingly, it can cut down on unnecessary expense and simplify the manufacturing process due to elimination of the unnecessary process of attaching a phase compensation film.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A reflective liquid crystal display, comprising:
a lower substrate including a reflective electrode and a lower orientation film;
an upper substrate opposed to the lower substrate, the upper substrate including a transparent substrate and an upper orientation film, the transparent substrate being capable of compensating a phase of λ/4 with an optical axis of a predetermined angle, the upper orientation film being formed on a surface of the transparent substrate opposed to the lower substrate;
a twisted nematic liquid crystal layer interposed between the lower substrate and the upper substrate, with a predetermined phase delay value (dΔ n); and
a polarizing plate attached to a outer surface of the upper substrate not opposed to the lower substrate, having a predetermined polarizing axis.

2. A reflective liquid crystal display as claimed in claim 1, wherein the transparent substrate capable of compensating the phase of λ/4 is a glass substrate for completely circular-polarizing light of 550 nm wavelength.

3. A reflective liquid crystal display as claimed in claim 1, wherein the transparent substrate capable of compensating the phase of λ/4 is a glass substrate for changing a phase of light of 550 nm wavelength by λ/2.

4. A reflective liquid crystal display as claimed in claim 1, wherein the lower orientation film has a orientation angle of 0˜10° with respect to a horizontal line.

5. A reflective liquid crystal display as claimed in claim 1, wherein the upper orientation film has a orientation angle of −50˜−54° with respect to a horizontal line.

6. A reflective liquid crystal display as claimed in claim 1, wherein the liquid crystal layer has a phase delay value of 0.15˜0.17 μm.

7. A reflective liquid crystal display as claimed in claim 1, wherein the liquid crystal layer has a twisted angle of 50˜60° with respect to the left direction.

8. A reflective liquid crystal display as claimed in claim 1, wherein the polarizing plate has a polarizing axis with an angle of 112˜120° with respect to a horizontal line.

9. A reflective liquid crystal display as claimed in claim 1, wherein the reflective electrode has a flexural surface.

10. A reflective liquid crystal display comprising:
a lower substrate including a reflective electrode;
a lower orientation film formed on the reflective electrode, having an angle of 0˜10° with respect to a horizontal line;
an upper substrate opposed to the lower substrate, being made of transparent substrate capable of compensating a phase of λ/4 with an optical axis of a predetermined angle;
an upper orientation film formed on the upper substrate, having orientation angle of −50˜31 54° with respect to a horizontal line;
a twisted nematic liquid crystal layer interposed between the lower substrate and the upper substrate, with a predetermined phase delay value (dΔ n) of 0.15˜0.17 μm, having twist angle of 50˜60° with respect to the left direction; and
a polarizing plate attached to a outer surface of the upper substrate not opposed to the lower substrate, having a predetermined polarizing axis with an angle of 112˜120° with respect to a horizontal line.

11. A reflective liquid crystal display as claimed in claim 10, wherein the transparent substrate capable of compensating the phase of λ/4 is a glass substrate for completely circular-polarizing light of 550 nm wavelength.

12. A reflective liquid crystal display as claimed in claim 10, wherein the transparent substrate capable of compensating the phase of λ/4 is a glass substrate for changing a phase of light of 550 nm wavelength into λ/4

13. A reflective liquid crystal display as claimed in claim 10, wherein the reflective electrode has a flexural surface.
